(19) United States
(12) Patent Application Publication
(10) Pub. No.: US 2018/0247632 A1
(43) Pub. Date: Aug. 30, 2018

(54) DAMPING HOT MELT COMPOSITION

(71) Applicant: Henkel AG & Co, KGAA, Duesseldorf (DE)

(72) Inventors: Xin BAI, Shanghai (CN); Yew-Guan Low, Shanghai (CN); Qi Chen, Shanghai (CN)

(21) Appl. No.: 15/966,156

(22) Filed: Apr. 30, 2018

Related U.S. Application Data
(63) Continuation of application No. PCT/CN2015/093362, filed on Oct. 30, 2015.

(51) Int. Cl. G10K 11/162; B32B 37/12; C08L 9/06; C08L 23/14; C08K 5/053; C08K 5/101; C08L 93/04

(52) U.S. Cl. CPC G10K 11/162; B32B 37/1207; C08L 9/06; C08L 23/14; C08L 2205/03; C08K 5/101; C08L 93/04; B32B 2037/1215; C08K 5/053

(57) ABSTRACT

The present invention relates to a hot melt composition, which is suitable as a damping, preferably a sound deadening, composition comprising
i) at least one poly-α-olefin;
ii) at least one elastomeric styrene based copolymer;
iii) at least one tackifier;
iv) at least one macrocycle; and optionally
v) at least one additive, preferably selected from fillers; stabilizers; colorants; pigments; waxes; thermoplastic compounds having a melt index of 600 to 5000 at 190° C./2.16 kg (ASTM D1238) selected from ethylene vinyl acetate (EVA), ethylene acrylic acid (EAA), alkyl acrylates, alkyl methylacrylates (EMA), ethylene 2-ethyl hexyl acrylate (EEHA) polymers or combinations thereof; moisture scavengers; or combinations thereof. Furthermore, the present invention relates to a dampening, preferably a sound deadening, article comprising the hot melt composition of the present invention and the use of the hot melt composition of the present invention in dampening, preferably sound deadening.

### FIELD OF THE INVENTION

The present invention relates to specific hot melt compositions which is suitable as a damping, preferably a sound deadening composition. Furthermore, the invention relates to the use of the hot melt composition according to the present invention in dampening, preferably sound deadening, more preferably in damping, preferably sound deadening, mats, pads, sheets and tapes most preferably in damping, preferably sound deadening, mats, pads, sheets and tapes for the automotive industry, especially in car bodies. The hot melt compositions according to the present invention show a low volatile-organic-compound (VOC) and fogging release.

### BACKGROUND OF THE INVENTION

Damping and/or sound deadening materials, also referred to as sound deadening materials or as damping materials only in the following, are widely used in transportation, appliances and constructions to reduce noise, vibration and harshness. In the automotive field, interior floor pans, roofs and doors of a car need damping materials to decrease structure-borne noise that can be transmitted through car-body substrates. Materials with good damping and/or sound deadening performance, low density and low volatile-organic-compound (VOC) release at the application temperature are highly appreciated in the automotive industry.

According to the application methods in car bodies, there are two kinds of damping materials. One kind of damping material is pre-cut pieces of melt pads which are made of asphaltic materials, butylene rubbers or pressure sensitive adhesives (PSA). The other kind of damping material is sprayable coatings which are also referred to as liquid applied sound deadeners.

For example WO 2015/135114 A discloses polyolefin based sound deadening hot melt compositions. Even though the disclosed adhesives have good sound deadening performance the low volatile-organic-compound (VOC) release of the disclosed adhesives is not satisfying. Therefore, there exist a need in the automotive market for improved polyolefin based sound deadening hot melt compositions which show less low volatile-organic-compound release while having a damping, preferably good sound deadening, performance.

### SUMMARY OF THE INVENTION

It has been surprisingly found by the present inventors that this need can be solved by a hot melt composition comprising of at least one poly-α-olefin, at least one elastomeric styrene based copolymer, at least one tackifier, and at least one macrocycle.

### DETAILED DESCRIPTION OF THE INVENTION

In the present specification the terms “a” and “an” and “at least one” are the same as the term “one or more” and can be employed interchangeably.

In the present specification the term “essentially” is to be interpreted within the common expectation of the skilled person in the respective field. Preferably the term “essentially” is to be considered to be at least 98%, 99%, 99.5%, 99.8%, 99.9% of the respective value referred to, more preferably at least 99.9%, most preferably 99.99%.

In particular the present invention relates to
1. A hot melt composition, which is suitable as a damping, preferably a sound deadening, composition comprising, preferably essentially consisting of, more preferably consisting of,
   i) at least one poly-α-olefin;
   ii) at least one elastomeric styrene based copolymer;
   iii) at least one tackifier;
   iv) at least one macrocycle; and optionally
   v) at least one additive, preferably selected from fillers; stabilizers; colorants; pigments; waxes; thermoplastic compounds having a melt index of 600 to 5000 at 190° C./2.16 kg (ASTM D1238) selected from ethylene vinyl acetate (EVA), ethylene acrylic acid (EAA), alkyl acrylates, alkyl methylacrylates (EMA), ethylene 2-ethyl hexyl acrylate (EEHA) polymers or combinations thereof; moisture scavengers; or combinations thereof.
2. The hot melt composition according to item 1, wherein
   i) is at least one propylene based poly-α-olefin which has been obtained by metallocene catalysis;
   preferably wherein the at least one propylene based poly-α-olefin has a Melt Flow Rate (MFR) of less than 100 g/10 min, more preferably less than 50 g/10 min, most preferably less than 25 g/10 min measured at 230° C./2.16 kg according to ASTM D1238; and/or
   preferably the propylene content in the propylene based poly-α-olefin is more than 50 wt %, more preferably more than 60 wt %, most preferably more than 70 wt %.
3. The hot melt composition according to item 1 or 2, wherein the at least one poly-α-olefin has a weight average molecular weight of at least 1,000 g/mol, preferably 5,000 g/mol, more preferably 10,000 g/mol; and/or
   preferably the upper limit is at most 100,000 g/mol, more preferably 80,000 g/mol, most preferably 60,000 g/mol.
4. The hot melt composition according to any of items 1 to 3, wherein
   i) is selected from copolymers of propylene and a comonomer selected from at least one C2 to C8 alkylene, preferably i) is a propylene octylene copolymer, propylene ethylene copolymer or a mixture thereof, more preferably is a propylene ethylene copolymer.
5. The hot melt composition according to any of items 1 to 4, wherein
   ii) the at least one elastomeric styrene based copolymer is selected from the group consisting of a styrene-isoprene-styrene block copolymers; styrene-isoprene-styrene/styrene-isoprene block copolymers; styrene-butadiene-styrene block copolymers; styrene-butadiene-styrene/styrene-butadiene block copolymers; styrene-butadiene block copolymers; styrene-ethylene-butylene-styrene block copolymers; styrene-ethylene-butylene-styrene/styrene-ethylene-butylene block copolymers; and styrene-ethylene-propylene-styrene/styrene-ethylene-propylene block copolymers; and combinations thereof,
   more preferably ii) is selected from styrene-isoprene copolymers; styrene-isoprene-styrene block copolymers or combinations thereof.
6. The hot melt composition according to item 5, wherein the elastomeric styrene based copolymer has a weight average molecular weight of at least 1,000 g/mol, preferably 5,000 g/mol, more preferably 10,000 g/mol; and/or
   preferably the upper limit is at most 100,000 g/mol, more preferably 80,000 g/mol, most preferably 60,000 g/mol.
7. The hot melt composition according to any one of items 1 to 6, wherein
   iii) the at least one tackifier is selected from
   (a) natural and modified rosins like gum rosins, wood rosins, tall oil rosins, distilled rosins, hydrogenated rosins, dimerized rosins, polymerized rosin;
   (b) glycerol and pentaerythritol esters of natural and modified rosins like glycerol esters of pale; wood rosins; glycerol esters of hydrogenated rosins; the glycerol esters of polymerized rosins; pentaerythritol esters of hydrogenated rosins; and phenolic-modified pentaerythritol esters of rosins;
   (c) copolymers and terpolymers of natural terpenes, such as styrene/terpene and alpha methyl styrene/terpene;
   (d) polyterpene resins resulting from the polymerization of terpene hydrocarbons, such as the bicyclic monoterpene known as pinene, in the presence of Friedel-Crafts catalysts at moderately low temperatures as well as hydrogenated polyterpene resins;
   (e) phenolic modified terpene resins and hydrogenated derivatives thereof;
   (f) aliphatic petroleum hydrocarbon resins resulting from the polymerization of monomers consisting primarily of olefins and diolefins as well as the hydrogenated aliphatic petroleum hydrocarbon resins;
   (g) cyclic petroleum hydrocarbon resins and the hydrogenated derivatives thereof;
   (h) alkyl phenolic resins and; combinations thereof, preferably
   iii) is selected from (h) thermoplastic alkyl phenolic resins; and/or
   the at least one tackifier has a number average molecular weight of 50 to 2000 g/mol, more preferably the at least one tackifier is selected from (h) alkyl phenolic resins having a softening point from 120 to 140° C.
8. The hot melt composition according to any one of items 1 to 7, wherein
   iv) the at least one macrocycle is selected from cyclodextrins, calixarene and cucurbituril or combinations therefore,
   preferably iv) is cyclodextrin,
   more preferably iv) is β-cyclodextrin.
9. The hot melt composition according to any one of items 1 to 8, wherein
   i) is present in an amount of 10 to 40 wt.-%, preferably 15 to 35 wt.-% most preferably 18 to 25 wt.-%, based on the total weight of the composition.
10. The hot melt composition according to any one of items 1 to 9, wherein
   ii) is present in an amount of 1 to 25 wt.-%, preferably 5 to 20 wt.-% most preferably 7 to 15 wt.-%, based on the total weight of the composition.
11. The hot melt composition according to any one of items 1 to 10, wherein
   iii) is present in an amount of 1 to 25 wt.-%, preferably 5 to 20 wt.-% most preferably 7 to 15 wt.-%, based on the total weight of the composition.
12. The hot melt composition according to any one of items 1 to 11, wherein
   iv) is present in an amount of 0.1 to 10 wt.-%, preferably 0.5 to 7 wt.-% most preferably 1.5 to 5 wt.-%, based on the total weight of the composition.
13. The hot melt composition according to any one of items 1 to 12, wherein
   v) is present in an amount of 10 to 70 wt.-%, preferably 20 to 65 wt.-% most preferably 35 to 60 wt.-%, based on the total weight of the composition and/or
   v) the at least one additive is selected from filler and waxes or combinations thereof.
14. A damping, preferably a sound deadening, article comprising, preferably essentially consisting of, more preferably consisting of the hot melt composition according to any one of items 1 to 13.
15. Use of the hot melt composition according to any one of items 1 to 13 in dampening, preferably sound deadening, more preferably in damping or sound deadening mats, pads, sheets and tapes, most preferably in damping or sound deadening mats, pads, sheets and tapes for the automotive industry.

The hot melt composition according to the present invention comprises at least one propylene based poly-α-olefin which is obtainable by metallocene catalysis.

The manufacture of propylene based poly-α-olefins by metallocene catalysis is common in the art and the skilled person knows how to obtain such polymers. Examples on how to obtain such polymers are given for example in the general textbook J. Scheirs, W. Kaminsky, “Metallocene-based Polyolefins, Preparation, Properties, and Technology”, 2 Volume Set 1999, Wiley (ISBN: 978-0-471-98086-5).

The at least one propylene based poly-α-olefin can be a propylene homopolymer or a copolymer. Preferably the propylene based poly-α-olefin is selected from copolymers of propylene and a comonomer selected from at least one C2 to C8 alkylene, more preferably it is a propylene octylene copolymer or a propylene ethylene copolymer, most preferably it is a propylene ethylene copolymer.

The at least one propylene based poly-α-olefin has preferably a Melt Flow Rate (MFR) of less than 100 g/10 min, more preferably less than 50 g/10 min, most preferably less than 25 g/10 min measured at 230° C./2.16 kg according to ASTM D1238.

The at least one propylene based poly-α-olefin has preferably a propylene content of more than 50 wt.-%, more preferably more than 60 wt.-%, most preferably more than 70 wt.-%, based on the total weight of the respective propylene based poly-α-olefin.

The at least one propylene based poly-α-olefin has preferably a density of 0.8 to 1.2 g/m³, more preferably 0.8 to 1.0 g/m³, measured according to ASTM D1505.

Commercial available examples which are suitable as the at least one propylene based poly-α-olefin according to the invention are sold by Dow Chemical Co. under the trade name Engage or Versify, from Clariant under the trade name LICOCENE and from ExxonMobil Chemical under the trade name Vistamaxx, especially Vistamaxx 6202, Exact or LINXA.

The at least one poly-α-olefin preferably has a weight average molecular weight of at least 1,000 g/mol or 2,000 g/mol, or 3,000 g/mol or 4,000 g/mol, more preferably 5,000 g/mol or 6,000 g/mol, or 7,500 g/mol, most preferably 10,000 g/mol. It preferably has an upper limit of at most 100,000 g/mol or 90,000 g/mol, more preferably 80,000 g/mol or 70,000 g/mol, most preferably 60,000 g/mol. Any of the before mentioned upper limits can be combined with any of the before mentioned lower limits.

The hot melt composition of the present invention further comprises at least one elastomeric styrene based copolymer.

The manufacture of one elastomeric styrene based copolymer is common in the art and the skilled person knows how to obtain such polymers. Examples on how to obtain such polymers are given, e.g., in the paper of R. Velichkova et. Al. Journal of Polymer Science Part A: Polymer Chemistry, Vol. 29, Issue 8, pages 1107-1112 or in EP 1925637 A1 where respective copolymers are disclosed as component (a).

Preferably the at least one elastomeric styrene based copolymer is selected from the group consisting of styrene-isoprene-styrene block copolymers; styrene-isoprene-styrene/styrene-isoprene block copolymers; styrene-butadiene-styrene block copolymers; styrene-butadiene-styrene/styrene-butadiene block copolymers; styrene-butadiene block copolymers; styrene-ethylene-butylene-styrene block copolymers; styrene-ethylene-butylene-styrene/styrene-ethylene-butylene block copolymers; and styrene-ethylene-propylene-styrene/styrene-ethylene-propylene block copolymers; and combinations thereof. Most preferably the rubbery polymer is selected from styrene-isoprene copolymers; styrene-isoprene-styrene block copolymers or combinations thereof.

The elastomeric styrene based copolymers of the present invention have preferably a styrene content of 1 to 30 wt.-% or 5 to 25 wt.-%, more preferably 10 to 22 wt.-%, most preferably 15 to 20 wt.-% based on the total weight of the respective copolymer.

The elastomeric styrene based copolymers of the present invention have preferably a specific gravity measured according to ISO 1183 of 0.9 to 1.0, more preferably 0.92 to 0.97.

The elastomeric styrene based copolymers of the present invention have preferably a glass transition temperature of −25 to −5° C., more preferably −20 to −10, measured with DSC at a heating rate of −10° C./min.

The elastomeric styrene based copolymers of the present invention have preferably a Shore A Hardness of 30 to 80, more preferably 40 to 70, most preferably 50 to 65 measured according to DIN ISO 7619-1.

The rubbery polymer of the present invention have preferably a weight average molecular weight of at least 1,000 g/mol, or 2,500 g/mol more preferably 5,000 g/mol, or 7,500 g/mol most preferably 10,000 g/mol. It preferably has an upper limit of at most 100,000 g/mol, or 90,000 g/mol, more preferably 80,000 g/mol, or 70,000 g/mol or most preferably 60,000 g/mol.

Commercial available examples which are suitable as the at least one propylene based poly-α-olefin according to the invention are sold by Dow Chemical Co. under the trade name Engage or Versify, from Clariant under the trade name LICOCENE and from ExxonMobil Chemical under the trade name Vistamaxx, especially Vistamaxx 6202, Exact or LINXA.

The hot melt composition of the present invention further requires at least one tackifier.

The at least one tackifier is preferably selected from

(a) natural and modified rosins like gum rosins, wood rosins, tall oil rosins, distilled rosins, hydrogenated rosins, dimerized rosins, polymerized rosin;
(b) glycerol and pentaerythritol esters of natural and modified rosins like glycerol esters of pale; wood rosins; glycerol esters of hydrogenated rosins; the glycerol esters of polymerized rosins; pentaerythritol esters of hydrogenated rosins; and phenolic-modified pentaerythritol esters of rosins;
(c) copolymers and terpolymers of natural terpenes, such as styrene/terpene and alpha methyl styrene/terpene;
(d) polyterpene resins resulting from the polymerization of terpene hydrocarbons, such as the bicyclic monoterpene known as pinene, in the presence of Friedel-Crafts catalysts at moderately low temperatures as well as hydrogenated polyterpene resins;
(e) phenolic modified terpene resins and hydrogenated derivatives thereof;
(f) aliphatic petroleum hydrocarbon resins resulting from the polymerization of monomers consisting primarily of olefins and diolefins as well as the hydrogenated aliphatic petroleum hydrocarbon resins;
(g) cyclic petroleum hydrocarbon resins and the hydrogenated derivatives thereof;
(h) alkyl phenolic resins and; combinations thereof.

The at least one tackifier according to the present invention preferably has a number average molecular weight of 50 to 2000 g/mol, more preferably 100 to 1000 g/mol, most preferably 250 to 750 g/mol.

In preferred embodiments of the invention the at least one tackifier is selected from thermoplastic alkyl phenolic resins, more preferably alkyl phenolic resins having a softening point of 120 to 140° C. (ASTM D6493).

In a more preferred embodiment of the invention the at least one tackifier is selected from thermoplastic alkyl phenolic resins having a number average molecular weight of 50 to 2000 g/mol, more preferably 100 to 1000 g/mol, most preferably 250 to 750 g/mol, most preferably they additionally have a softening point of 120 to 140° C.

The hot melt composition of the present invention further requires at least one macrocycle. Macrocyles are compounds which include rings of at least 8 atoms. In preferred embodiments the at least one macrocycle is selected from cyclodextrins, calixarene and cucurbituril or combinations therefore, more preferably the at least one macrocycle is cyclodextrin, most preferably it is β-cyclodextrin.

The hot melt composition of the present invention can optionally further comprise at least one additive. The at least one additive is preferably selected from fillers; stabilizers; colorants; pigments; waxes; thermoplastic compounds having a melt index of 600 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) polymers or combinations thereof; moisture scavengers; or combinations thereof. More preferably from fillers stabilizers and; thermoplastic compounds having a melt index of 600 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) polymers or combinations thereof, or combinations thereof.

In most preferred embodiments of the present invention the additive is selected from thermoplastic compounds having a melt index of 600 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) polymers or combinations thereof, preferably the additive is ethylene vinyl acetate.

The ethylene vinyl acetate (EVA), ethylene acrylic acid (EAA), alkyl acrylates, alkyl methylacrylates (EMA), ethylene 2-ethyl hexyl acrylate (EEHA) have preferably a density of from 0.85 to 0.99 g/cm³, more preferably 0.9 to 0.97 g/cm³, most preferably 0.95 to 0.96 g/cm³ (measured according to ASTM D1505).

The ethylene vinyl acetate (EVA), ethylene acrylic acid (EAA), alkyl acrylates, alkyl methylacrylates (EMA), ethylene 2-ethyl hexyl acrylate (EEHA) have preferably a melt viscosity (at 190° C.) of 500 to 20,000 mPas, more preferably 1,000 to 10,000 mPas, most preferably 5,000 to 9,000 mPas (measured according to ASTM D3236).

These thermoplastic polymers are common in the art and a skilled person knows how to obtain those polymers. Commercial available examples which are suitable as the at least one thermoplastic polymer according to the invention are sold by ExxonMobil Chemical under the trade name Escorene, especially Escorene UL 8705.

To obtain the hot melt composition the different components are blended together by common technics in the art. This can be done in any known device, e.g., batch reactor, extruder, mixer, kneader or similar machines.

### EXAMPLES

Test Methods

Molecular Weight Determination

The respective compounds/compositions can be analysed for number average or weight average molecular weight by Gel Permeation Chromatography (GPC). The number average molecular weight (Mn) and weight average molecular weight (Mw) can be determined based on an external calibration that is carried out with polystyrene standards.

Damping Loss Factor

The damping loss factor was determined according to the standard test method ASTM E765-05 and denoted as CLF (composite loss factor). The damping loss factor at 200 Hz was obtained through the interpolation between the 2^{nd} and 3^{rd} order frequency damping ratio following the method in SAE J1637-07.

The length of the substrate metal bar was 240 mm, the thickness of the substrate metal bar was 1 mm and the width of the substrate metal bar was 10 mm. The sample length on top of the substrate was 216 mm. All The samples thickness were 2.5 mm and all the samples width were 10 mm.

Fogging Test

In this procedure, the test specimen is heated in a beaker assembly in a fog testing unit. A fog testing unit has a controlled heating unit with multiple chambers for a typical temperature range from 60° C. to 120° C. Cooling of the glass plate for each beaker in the unit is required with a typical temperature range from 20° C. to 40° C. The heating unit and the cooling system must be able to maintain the temperatures to within +0.5° C. The cooling plates, which are laid upon the glass plates, should apply a weight of approximately 1 kg to ensure an adequate seal with the beaker. The fog is collected on a glass plate and the fog number is determined by measuring the difference in gloss value according to test method SAE J1756:2006 before and after testing. The higher the measured transmittance the lower the VOC release.

The heating temperature should be 100° C.±0.5° C. and the cooling plate temperature 21° C.±0.5° C. for a duration of 3 h±0.05 h, followed by 1 h±0.05 h of conditioning at 21° C.±2° C. and 50%±5% RH.

Dampening materials 1 to 9 (examples 1 to 9) were prepared using the components shown in the respective table.

The preparation processes of examples 1 to 9 are the same and are illustrated by the preparation process for example 1 in the following.

First, all components of Example 1 as listed in Table 1 were weighted and mixed in a Z-blade mixer, then poured out and put onto a hot presser, on which the composition was pressed into a sheet with a thickness of 2.5 mm at 140° C. for 1 min, under pressure of 1000 kgf. The source of fogging was first investigated. The fogging test was taken individually of each component.

In the following tables all amount are given in wt.-%, based on the total weight of the respective composition.

### Examples 1 to 4

TABLE 1

| | | Ex. 2 | Ex. 3 | Ex. 4 |
|---|---|---|---|---|
| Components | Ex. 1 | (comparative) | (comparative) | (comparative) |
| Vistamaxx 6202 | 19.61 | 20.00 | 19.61 | 19.61 |
| (C3/C2 Poly | | | | |
| α-olefin) | | | | |
| Hybrar 5125 (SIS | 9.80 | 10.00 | 9.80 | 9.80 |
| Copolymer) | | | | |
| Phenolite TD-2640 | 9.80 | 10.00 | 9.80 | 9.80 |
| (Tackifier/allcyl | | | | |
| phenolic resin) | | | | |
| UL 8705 (EVA) | 14.71 | 15.00 | 14.71 | 14.71 |
| Graphite (Filler) | 44.12 | 45.00 | 44.12 | 44.12 |
| β-Cyclodextrin | 1.96 | 0.00 | 0.00 | 0.00 |
| (macrocycle) | | | | |
| Activated carbon | 0.00 | 0.00 | 1.96 | 0.00 |
| (Additive) | | | | |
| Zeolite (Additive) | 0.00 | 0.00 | 0.00 | 1.96 |
| 200 Hz CLF @ RT | 0.20 | 0.20 | 0.20 | 0.20 |
| Transmittance (%) | 97.3 | 54.5 | 51.7 | 52.8 |

Several porous fillers were chosen to test the ability of absorbing small molecules and thus avoid VOC release. We have surprisingly found that cyclodextrin in contrast to activated carbon and zeolite has the ability to chemically bond with small molecules, rather than simply physical absorb it which seems to be important to lower the VOC release at higher temperatures. In this application the fogging test was performed at 100° C.

### Examples 5 and 6

TABLE 2

| Components | Ex. 1 | Ex. 5 | Ex. 6 |
|---|---|---|---|
| Vistamaxx 6202 (C3/C2 Poly α-olefin) | 19.61 | 19.61 | 19.61 |
| Hybrar 5125 (SIS Copolymer) | 9.80 | 9.80 | 9.80 |
| Phenolite TD-2640 (Tackifier/alkyl | 9.80 | 9.80 | 9.80 |
| phenolic resin) | | | |
| UL 8705 (EVA) | 14.71 | 14.71 | 14.71 |
| Graphite (Filler) | 44.12 | 44.12 | 44.12 |
| β-Cyclodextrin (macrocycle) | 1.96 | 0.00 | 0.00 |
| α-Cyclodextrin (macrocycle) | 0.00 | 1.96 | 0.00 |
| γ-Cyclodextrin (macrocycle) | 0.00 | 0.00 | 1.96 |
| 200 Hz CLF @ RT | 0.20 | 0.20 | 0.20 |
| Transmittance (%) | 97.3 | 60.7 | 61.5 |

Furthermore, it has been surprisingly found that β-cyclodextrin shows improved low VOC release compared the alpha and gamma cyclodextrin.

### Examples 7 to 9

TABLE 3

| | | Ex. 7 | | |
|---|---|---|---|---|
| Components | Ex. 1 | (Comparative) | Ex. 8 | Ex. 9 |
| Vistamaxx 6202 (Elastomer) | 19.61 | 20.00 | 19.80 | 19.42 |
| Hybra 5125 (Rubber) | 9.80 | 10.00 | 9.90 | 9.71 |
| Phenolite TD-2640 (Tackifier) | 9.80 | 10.00 | 9.90 | 9.71 |
| UL 8705 (EVA) | 14.71 | 15.00 | 14.85 | 14.56 |
| Graphite (Filler) | 44.12 | 45.00 | 44.55 | 43.69 |
| β-Cyclodextrin (macrocycle) | 1.96 | 0.00 | 0.99 | 2.91 |
| 200 Hz CLF @ RT | 0.20 | 0.20 | 0.20 | 0.20 |
| Transmittance (%) | 97.3 | 54.5 | 70.9 | 97.4 |

The example show that the malodour conteractant can be employed in different wt.-%.

1: A sound deadening hot melt composition, which is suitable as a dampening, comprising,
i) at least one poly-α-olefin;
ii) at least one elastomeric styrene based copolymer;
iii) at least one tackifier;
iv) at least one macrocycle; and
v) optionally, an additive selected from fillers; stabilizers;
colorants; pigments; waxes; thermoplastic compounds having a melt index of 600 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) polymers or combinations thereof; moisture scavengers; or combinations thereof.

2: The sound deadening hot melt composition according to claim 1, wherein
i) the at least one poly-α-olefin is at least one propylene based poly-α-olefin which has been obtained by metallocene catalysis.

3: The sound deadening hot melt composition according to claim 1, wherein the at least one poly-α-olefin has a weight average molecular weight of at least 1,000 g/mol; and less than 100,000 g/mol.

4: The sound deadening hot melt composition according to claim 2, wherein
i) the at least one poly-α-olefin is selected from copolymers of propylene and a comonomer selected from at least one C2, C4 to C8 alkylene.

5: The sound deadening hot melt composition according to claim 1, wherein
ii) the at least one elastomeric styrene based copolymer is selected from the group consisting of a styrene-isoprene-styrene block copolymers; styrene-isoprene-styrene/styrene-isoprene block copolymers; styrene-butadiene-styrene block copolymers; styrene-butadiene-styrene/styrene-butadiene block copolymers; styrene-butadiene block copolymers; styrene-ethylene-butylene-styrene block copolymers; styrene-ethylene-butylene-styrene/styrene-ethylene-butylene block copolymers; and styrene-ethylene-propylene-styrene/styrene-ethylene-propylene block copolymers; and combinations thereof.

6: The sound deadening hot melt composition according to claim 5, wherein the elastomeric styrene based copolymer has a weight average molecular weight of at least 1,000 g/mol and less than 100,000 g/mol.

7: The sound deadening hot melt composition according to
claim 1, wherein
iii) the at least one tackifier is selected from
(a) natural and modified rosins like gum rosins, wood rosins, tall oil rosins, distilled rosins, hydrogenated rosins, dimerized rosins, polymerized rosin;
(b) glycerol and pentaerythritol esters of natural and modified rosins like glycerol esters of pale; wood rosins; glycerol esters of hydrogenated rosins; the glycerol esters of polymerized rosins; pentaerythritol esters of hydrogenated rosins; and phenolic-modified pentaerythritol esters of rosins;
(c) copolymers and terpolymers of natural terpenes, such as styrene/terpene and alpha methyl styrene/terpene;
(d) polyterpene resins resulting from the polymerization of terpene hydrocarbons, such as the bicyclic monoterpene known as pinene, in the presence of Friedel-Crafts catalysts at moderately low temperatures as well as hydrogenated polyterpene resins;
(e) phenolic modified terpene resins and hydrogenated derivatives thereof;
(f) aliphatic petroleum hydrocarbon resins resulting from the polymerization of monomers consisting primarily of olefins and diolefins as well as the hydrogenated aliphatic petroleum hydrocarbon resins;
(g) cyclic petroleum hydrocarbon resins and the hydrogenated derivatives thereof;
(h) alkyl phenolic resins and; combinations thereof.

8: The sound deadening hot melt composition according to claim 1, wherein
iv) the at least one macrocycle is selected from cyclodextrins, calixarene and cucurbituril or combinations therefore.

9: The sound deadening hot melt composition according to claim 1, wherein
i) the at least one poly-α-olefin is present in an amount of 10 to 40 wt. % based on the total weight of the composition.

10: The sound deadening hot melt composition according to claim 1, wherein
ii) the at least one elastomeric styrene based copolymer is present in an amount of 1 to 25 wt. %, based on the total weight of the composition.

11: The sound deadening hot melt composition according to claim 1, wherein
iii) the at least one tackifier is present in an amount of 1 to 25 wt. %, 20 based on the total weight of the composition.

12: The sound deadening hot melt composition according to claim 1, wherein
iv) the at least one macrocycle is present in an amount of 0.1 to 10 wt.-%, based on the total weight of the composition.

13: The sound deadening hot melt composition according to claim 1, wherein
v) the additive is present in an amount of 10 to 70 wt.-%, most based on the total weight of the composition and/or
v) the at least one additive is selected from filler, waxes, thermoplastic compounds having a melt index of 600 to 5000 at 190° C./2.16 kg selected from ethylene vinyl acetate (EVA), ethylene acrylic acid (EAA), alkyl acrylates, alkyl methylacrylates (EMA), ethylene 2-ethyl hexyl acrylate (EEHA) polymers or combinations thereof, or combinations thereof.

14: A dampening article comprising the sound deadening hot melt composition according to claim 1.

15: The damping article of claim 14, which is a mat, pad, sheet and tape.
